(19) United States
(12) Patent Application Publication
(10) Pub. No.: US 2020/0156283 A1
(43) Pub. Date: May 21, 2020

(54) A PROCESS FOR PRODUCING A THREE-DIMENSIONAL GREEN BODY BY A FUSED FILAMENT FABRICATION (FFF) PROCESS

(71) Applicant: BASF SE, Ludwigshafen am Rhein (DE)

(72) Inventors: Jordan Thomas KOPPING, Ludwigshafen am Rhein (DE); Lothar WELLER, Ludwigshafen am Rhein (DE); Felix Arndt VOLKMANN, Ludwigshafen am Rhein (DE); Sebastian Mathias SCHILLO, Ludwigshafen am Rhein (DE); Daniel LEUTZ, Ludwigshafen am Rhein (DE)

(21) Appl. No.: 16/634,602

(22) PCT Filed: Jul. 31, 2018
(86) PCT No.: PCT/EP2018/070811

§ 371 Date: Jan. 28, 2020

(30) Foreign Application Priority Data
Aug. 2, 2017 (EP) 17184569.6

(51) Int. Cl. B28B 1/00; B22F 3/00; C04B 35/634; C04B 35/628

(52) U.S. Cl. CPC B28B 1/001; B22F 3/008; C04B 35/63408; C04B 35/63488; C04B 35/62897; B33Y 10/00; C04B 35/63464; C04B 35/63468; C04B 35/6346; C04B 2235/6026; C04B 2235/6021; C04B 35/63456

(57) ABSTRACT

The invention relates to a process for producing a three-dimensional green body by a fused filament fabrication process employing at least one filament, which comprises a core material (CM) coated with a layer of a shell material (SM), and a three-dimensional extrusion printer (3D printer). The three-dimensional extrusion printer 0 contains at least one nozzle and at least one mixing element. The invention further relates to three-dimensional objects and an extruded strand obtained by the process.

The invention relates to a process for producing a three-dimensional green body by a fused filament fabrication process employing at least one filament, which comprises a core material (CM) coated with a layer of a shell material (SM), and a three-dimensional extrusion printer (3D printer). The three-dimensional extrusion printer contains at least one nozzle and at least one mixing element. The invention further relates to three-dimensional objects and an extruded strand obtained by the process.

One of the most commonly used 3D printing technologies or additive manufacturing technology is the fused deposition modeling (FDM), also known as fused filament fabrication process (FFF). For the production of three-dimensional objects, usually filaments of thermoplastic materials, provided on a spool, are deposited layer-by-layer through a heated nozzle on a base. Therefore, the thermoplastic material is heated to a temperature past its melting and/or glass transition temperature. The thermoplastic material and the temperature gradient are selected in order enable its solidification essentially immediately upon contacting the base or a preceding layer of thermoplastic material extruded.

In order to form each layer, drive motors are provided to move the base and/or the extrusion nozzle (dispending head) relative to each other in a predetermined pattern along the x-, y- and z-axis. Fused deposition modeling (FDM) was first described in U.S. Pat. No. 5,121,329.

Typical materials for the production of three-dimensional objects are thermoplastic materials.

US 2014/0134334 A1 discloses a fused deposition modeling (FDM) process for producing multicolored three-dimensional objects and describes the coating of thermoplastic polymer filaments with a coating unit upstream to a nozzle in which the filaments are melted and then extruded to produce a three-dimensional object. The coating predominantly remains at the surface of the extruded material, as very little mixing occurs during the extrusion process.

WO 2012/152511 likewise describes a process for producing multicolored three-dimensional objects via fused deposition modeling (FDM) by coloring a thermoplastic polymer strand in the nozzle. The device used in the process comprises at least two printheads, with one printhead printing a support material and the other printhead printing the build material. In order to obtain a particularly good color image, the thermoplastic polymer strand is subjected to a mixing device which is implemented in the nozzle of the printhead for printing the build material.

The production of three-dimensional metallic or ceramic objects by fused filament fabrication is only possible if the metal or ceramic material has a low melting point so that it can be heated and melted by the nozzle. If the metal or ceramic material has a high melting point, it is necessary to provide the metal or ceramic material in a binder composition to the extrusion nozzle. The binder composition usually comprises a thermoplastic material. When depositing the mixture of a metal or ceramic material in a binder on a base, the formed three-dimensional object is a so called “green body” which comprises the metal or ceramic material in a binder. To receive the desired metallic or ceramic object, the binder has to be removed to form a so called “brown body” and finally the object has to be sintered.

WO 2016/012486 describes the use of mixtures comprising an inorganic powder, such as a metal, a metal alloy or a ceramic material, and a binder comprising a polyoxymethylene, a polyolefin and other polymers in a fused filament fabrication process. The mixtures are melted in the nozzle of a 3D printer and are deposited layer by layer to form a three-dimensional object. High amounts of inorganic powder in the mixtures have the disadvantage that the resulting filaments generally are very brittle and thus, are more difficult to handle.

PCT/EP2016/066187 describes filaments comprising a core material and a shell material, with the core material comprising an inorganic powder and a binder, and the shell material comprising a thermoplastic polymer, an inorganic powder and optionally additives. The filaments described in PCT/EP2016/066187 are more stable and can be rolled on a spool, which renders them easier to store and process than those disclosed in WO 2016/012486. The filaments are further used in fused deposition modeling to form three-dimensional objects.

EP 16203641.2 discloses the use of filaments similar to those described in PCT/EP2016/066187 as a support material in a fused filament fabrication process. The filaments comprise a core material which contains a ceramic material precursor and a binder and further comprises a shell material which contains a thermoplastic polymer, among others.

The filaments disclosed in the prior art, and in particular those comprising inorganic materials such as metals, metal alloys or ceramics, have the disadvantage that the respective green bodies and the brown bodies formed from said filaments via fused deposition modeling tend to exhibit a rather low stability. In addition, green bodies and brown bodies often exhibit breakpoints and the brown bodies are especially prone to damage, since the removal of the binder can easily result in the collapse of the brown bodies.

The object underlying the present invention is, therefore, to provide a new process for producing three-dimensional objects such as green bodies that do not exhibit the aforementioned disadvantages.

This object is achieved by a process for producing a three-dimensional green body by a fused filament fabrication process employing at least one filament and a three-dimensional extrusion printer (3D printer), wherein

at least one filament comprises a core material (CM) coated with a layer of shell material (SM), wherein
the core material (CM) comprises the components (a) to (c)
(a) 30 to 80% by volume, based on the total volume of the core material (CM) of at least one inorganic powder (IP),
(b) 20 to 70% by volume, based on the total volume of the core material (CM) of at least one binder (B) comprising component (b1)
(b1) at least one polymer (P)
(c) 0 to 20% by volume, based on the total volume of the core material (CM) of at least one additive (A),
   and the shell material (SM) comprises the components (d) to (f)
(d) 75 to 100% by volume, based on the total volume of the shell material (SM) of at least one thermoplastic polymer (TP),
(e) 0 to 20% by volume, based on the total volume of the shell material (SM) of the at least one inorganic powder (IP),
(f) 0 to 25% by volume, based on the total weight of the shell material (SM) of the at least one additive (A),
   and the 3D printer contains at least one nozzle and at least one mixing element.

It has surprisingly been found that 3D printers containing at least one nozzle and at least one mixing element lead to increased stability of the printed structure during post processing of green and brown. The inventive process is, therefore, easier and more efficient to carry out and allows for the production of three-dimensional objects with more complex and filigree structures.

A further advantage is that, preferably, a more homogeneous distribution of the at least one inorganic powder (IP), the at least one binder (B), the at least one thermoplastic polymer (TP) and, if present, the at least one additive (A) can be obtained on the total surface area of the strands extruded by the at least one nozzle of the 3D printer due to the at least one mixing element in the 3D printer. The more homogeneous distribution on the total surface area of the strands used to form the green body also prevents the formation of holes during the removal of the binder, resulting in more stable brown bodies.

The invention is specified in more detail as follows.

The first subject of the present invention is a process for producing a three-dimensional green body by a fused filament fabrication process employing at least one filament and a three-dimensional extrusion printer (3D printer), wherein

at least one filament comprises a core material (CM) coated with a layer of shell material (SM), wherein
the core material (CM) comprises the components (a) to (c)
(a) 30 to 80% by volume, based on the total volume of the core material (CM) of at least one inorganic powder (IP),
(b) 20 to 70% by volume, based on the total volume of the core material (CM) of at least one binder (B) comprising component (b1)
(b1) at least one polymer (P)
(c) 0 to 20% by volume, based on the total volume of the core material (CM) of at least one additive (A),
   and the shell material (SM) comprises the components (d) to (f)
(d) 75 to 100% by volume, based on the total volume of the shell material (SM) of at least one thermoplastic polymer (TP),
(e) 0 to 20% by volume, based on the total volume of the shell material (SM) of the at least one inorganic powder (IP),
(f) 0 to 25% by volume, based on the total weight of the shell material (SM) of the at least one additive (A),
   and the 3D printer contains at least one nozzle and at least one mixing element.

The filament to be employed in the process according to the invention comprises a core material (CM) coated with a layer of shell material (SM).

The filament may exhibit any length and/or diameter as deemed appropriate by the person skilled in the art.

Preferably, the diameter of the filament is 1.5 to 3.5 mm, more preferably 2.0 to 3.1 mm, most preferably 2.6 to 3.0 mm.

The layer of shell material (CM) may have any thickness as deemed appropriate by the person skilled in the art.

Preferably, the thickness of the layer of shell material (SM) is 0.05 to 0.5 mm, more preferably 0.09 to 0.3 mm, most preferably 0.1 to 0.25 mm.

The core material (CM) may have any diameter deemed as appropriate by the person skilled in the art.

Preferably the diameter of the core material is 1.3 to 3.0 mm, more preferably 1.9 to 2.7 mm, most preferably 2.2 to 2.7 mm.

The core material (CM) comprises the components (a) to (c).

The core material (CM) comprises as component (a) 30 to 80% by volume, preferably 40 to 68% by volume, more preferably 50 to 65% by volume, based on the total volume of the core material (CM), of at least one inorganic powder (IP).

The terms “component (a)” and “inorganic powder (IP)” for the purpose of the present invention are synonymous and are used interchangeably throughout the present invention.

As component (a), any known inorganic powder (IP) can be used. Preferably, a sinterable inorganic powder (IP) is used as component (a). More preferably, the inorganic powder (IP) is a powder of at least one inorganic material selected from the group consisting of a metal, a metal alloy and a ceramic material precursor, most preferably the at least inorganic powder is a metal or a metal alloy, particularly preferably, the at least inorganic powder is a metal.

“An inorganic powder (IP)” means precisely one inorganic powder (IP) as well as a mixture of two or more inorganic powders (IP). The same holds true for the term “an inorganic material”. “An inorganic material” means precisely one inorganic material as well as mixtures of two or more inorganic materials.

“A metal” means precisely one metal as well as mixtures of two or more metals. A metal within the present invention can be selected from any metal of the periodic table of the elements which is stable under the conditions of a fused filament fabrication process and which can form three-dimensional objects. Preferably, the metal is selected from the group consisting of aluminium, yttrium, titanium, zirconium, vanadium, niobium, chromium, molybdenum, tungsten, manganese, iron, carbonyl iron powder (CIP), cobalt, nickel, copper, silver, zinc and cadmium, more preferably, the metal is selected from the group consisting of titanium, niobium, chromium, molybdenum, tungsten, manganese, iron, carbonyl iron powder (CIP), nickel and copper. With particular preference, the metal is selected from the group consisting of titanium, iron and carbonyl iron powder (CIP).

Carbonyl iron powder (CIP) is highly pure iron powder, prepared by chemical decomposition of purified iron pentacarbonyl.

“A metal alloy” means precisely one metal alloy as well as mixtures of two or more metal alloys. Within the context of the present invention, the term “metal alloy” means a solid solution or a partial solid solution, which exhibits metallic properties and comprises a metal and another element. “A metal” means, as stated above precisely one metal and also mixtures of two or more metals. The same applies to “another element”. “Another element” means precisely one other element and also mixtures of two or more other elements.

Solid solution metal alloys exhibit a single solid phase microstructure while partial solid solution metal alloys exhibit two or more solid phases. These two or more solid phases can be homogeneously distributed in the metal alloy, but they can also be heterogeneously distributed in the metal alloy.

The metal alloys can be prepared according to any process known to the person skilled in the art. For example, the metal can be melted and the other element can be added to the molten metal. However, it is also possible, to add the metal and the other element directly to the core material (CM) without the preparation of a metal alloy before. The metal alloy will then be formed during the process of the preparation of the three-dimensional object.

Concerning the metal, the above-stated embodiments and preferences for the metal apply.

The other element can be selected from the metals described above. However, the other element differs from the metal comprised in the metal alloy.

The other element can be selected from any element of the periodic table, which forms a metal alloy that is stable under the conditions of a fused filament fabrication process or, which is stable or forms stable alloys with the metal under the conditions of a fused filament process. In a preferred embodiment of the present invention, the other element is selected from the group consisting of the aforementioned metals, boron, carbon, silicon, phosphorous, sulfur, selenium and tellurium. Particularly preferably, the at least one other element is selected from the group consisting of the aforementioned metals, boron, carbon, silicon, phosphorous and sulfur.

Preferably, the metal alloy comprises steel.

“A metal” means precisely one metal and also mixtures of two or more metals. The same relies to “a non-metal” and “a first metalloid”, as well as “a second metalloid”. “A non-metal” means precisely one non-metal and also mixtures of two or more non-metals. “A first metalloid” means precisely one first metalloid and also mixtures of two or more first metalloids. “A second metalloid” means precisely one second metalloid and also mixtures of two or more second metalloids.

Non-metals are known per se to the person skilled in the art. The non-metal can be selected from any non-metal of the periodic table. Preferably, the at least one non-metal is selected from the group consisting of carbon, nitrogen, oxygen, phosphorus and sulfur.

Metalloids are as well-known per se to the skilled person. The first metalloid and the second metalloid can be selected from any metalloid of the periodic table. Preferably, the first metalloid and/or the second metalloid are selected from the group consisting of boron and silicon. It should be clear that the first metalloid and the second metalloid differ from each other. For example, if the first metalloid is boron, then the second metalloid is selected from any other metalloid of the periodic table of the elements besides boron.

“A ceramic material precursor” means precisely one ceramic material precursor as well as mixtures of two or more ceramic material precursors. In the context of the present invention, the term “ceramic material precursor” means a non-metallic compound of a metal or a first metalloid, and a non-metal or a second metalloid.

The ceramic material obtained after sintering of the ceramic material precursor may have the same or a different chemical composition as the ceramic material precursor. For example, sintering of BaO may result in BaO and sintering of CaCO₃ may result in CaO.

If the at least one inorganic powder (IP) comprises a ceramic material precursor, the ceramic material precursor is preferably selected from the group consisting of oxides, carbides, borides, nitrides and silicides. More preferably, the ceramic material precursor is selected from the group consisting of MgO, CaO, SiO₂, Na₂O, K₂O, Al₂O₃, ZrO₂, Y₂O₃, SiC, Si₃N₄, TiB, AlN, CaCO₃, xAl₂O₃.ySiO₂.zH₂O (aluminum silicate), TiO₂, NaAlSi₃O₈, KAlSi₃O₈, CaAl₂Si₂O₈ (Feld-spar), iron oxide (FeO, Fe₂O₃, Fe₃O₄), BaO and mixtures thereof. Particularly preferred, the ceramic material precursor is selected from the group consisting of Al₂O₃, ZrO₂ and Y₂O₃.

If the inorganic powder (IP) comprises a ceramic material precursor, the respective ceramic material obtained after sintering of the ceramic material precursor may have the same or a different chemical composition as the ceramic material precursor.

For the preparation of the inorganic powder (IP), the inorganic material has to be pulverized. To pulverize the inorganic material, any method known to the person skilled in the art can be used. For example, the inorganic material can be ground. The grinding for example can take place in a classifier mill, in a hammer mill or in a ball bill.

The particle sizes of the inorganic powders (IP) used as component (a) are preferably from 0.1 to 80 μm, particularly preferably from 0.5 to 50 μm, more preferably from 0.1 to 30 μm, measured by laser diffraction.

The core material comprises (CM) comprises as component (b) 20 to 70% by volume, preferably 20 to 60% by volume, more preferably 20 to 50% by volume, based on the total volume of the core material (CM), of at least one binder (B).

The terms “component (b)” and “binder (B)” for the purpose of the present invention are synonymous and are used interchangeably throughout the present invention.

The binder (B) comprises a component (b1) which is at least one polymer (P).

Preferably, the binder (B) comprises 50 to 96% by weight, more preferably 60 to 90% by weight, most preferably 70 to 85% by weight of the at least one polymer (P), based on the total weight of the binder (B), as component (b1).

Preferably, the at least one polymer (P) is a polyoxymethylene (POM).

As component (b1), at least one polyoxymethylene (POM) may be used. “At least one polyoxymethylene (POM)” within the present invention means precisely one polyoxymethylene (POM) and also mixtures of two or more polyoxymethylenes (POM).

For the purpose of the present invention, the term “polyoxymethylene (POM)” encompasses both, polyoxymethylene (POM) itself, i. e. polyoxymethylene (POM) homopolymers, and also polyoxymethylene (POM) copolymers and polyoxymethylene (POM) terpolymers.

Polyoxymethylene (POM) homopolymers usually are prepared by polymerization of a monomer selected from a formaldehyde source (b1a).

The term “formaldehyde source (b1a) relates to substances which can liberate formaldehyde under the reaction conditions of the preparation of polyoxymethylene (POM).

The formaldehyde sources (b1a) are advantageously selected from the group of cyclic or linear formals, in particular from the group consisting of formaldehyde and 1,3,5-trioxane. 1,3,5-trioxane is particularly preferred.

Polyoxymethylene (POM) copolymers are known per se and are commercially available. They are usually prepared by polymerization of trioxane as main monomer. In addition, comonomers are concomitantly used. The main monomers are preferably selected from among trioxane and other cyclic or linear formals or other formaldehyde sources (b1a).

The expression “main monomers” is intended to indicate that the proportion of these monomers in the total amount of monomers, i. e. the sum of main monomers and comonomers, is greater than the proportion of the comonomers in the total amount of monomers.

Quite generally, polyoxymethylene (POM) has at least 50 mol-% of repeating units —CH₂O— in the main polymer chain. Suitable polyoxymethylene (POM) copolymers are in particular those which comprise the repeating units —CH₂O— and from 0.01 to 20 mol-%, in particular from 0.1 to 10 mol-% and very particularly preferably from 0.5 to 6 mol-% of repeating units of the formula (I),

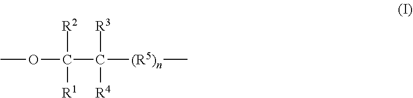

wherein
R¹ to R⁴ are each independently of one another selected from the group consisting of H, C₁-C₄-alkyl and halogen-substituted C₁-C₄-alkyl;
R⁵ is selected from the group consisting of a chemical bond, a (—CR^{5a}R^{5b}—) group and a (—CR^{5a}R^{5b}O—) group,
   wherein
R^{5a} and R^{5b} are each independently of one another selected from the group consisting of H and unsubstituted or at least monosubstituted C₁-C₄-alkyl,
   wherein the substituents are selected from the group consisting of F, Cl, Br, OH and C₁-C₄-alkyl;
n is 0, 1, 2 or 3.

If n is 0, then R⁵ is a chemical bond between the adjacent carbon atom and the oxygen atom. If R⁵ is a (—CR^{5a}R^{5b}O—) group, then the oxygen atom (O) of the (—CR^{5a}R^{5b}O—) group is bound to another carbon atom (C) of formula (I) and not to the oxygen atom (O) of formula (I). In other words, formula (I) does not comprise peroxide compounds. The same holds true for formula (II).

Within the context of the present invention, definitions such as C₁-C₄-alkyl, as for example defined above for the radicals R¹ to R⁴ in formula (I), mean that this substituent (radical) is an alkyl radical with a carbon atom number from 1 to 4. The alkyl radical may be linear or branched and also optionally cyclic. Alkyl radicals which have both a cyclic component and also a linear component likewise fall under this definition. Examples of alkyl radicals are methyl, ethyl, n-propyl, iso-propyl, butyl, iso-butyl, sec-butyl and tert-butyl.

In the context of the present invention, definitions, such as halogen-substituted C₁-C₄-alkyls, as for example defined above for the radicals R¹ to R⁴ in formula (I), mean that the C₁-C₄-alkyl is substituted by at least one halogen. Halogens are F (fluorine), Cl (chlorine), Br (bromine) and I (iodine).

The repeating units of formula (I) can advantageously be introduced into the polyoxymethylene (POM) copolymers by ring-opening of cyclic ethers as first comonomers (b1b). Preference is given to first comonomers (b1b) of the general formula (II),

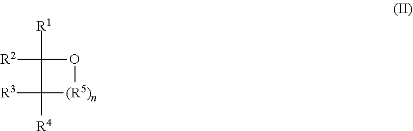

wherein
R¹ to R⁵ and n have the meanings as defined above for the general formula (I).

As first comonomers (b1b) mention may be made for example of ethylene oxide, 1,2-propylene oxide, 1,2-butylene oxide, 1,3-butylene oxide, 1,3-dioxane, 1,3-dioxolane and 1,3-dioxepane (=butanediol formal, BUFO) as cyclic ethers and also linear oligoformals or polyformals such as polydioxolane or polydioxepane. 1,3-dioxolane and 1,3-dioxepane are particularly preferred first comonomers (b1b), very particular preferred is 1,3-dioxepane as first comonomer b1b).

Polyoxymethylene (POM) polymers which can be obtained by reaction of a formaldehyde source together with the first comonomer (b1b) and a second comonomer (b1c) are likewise suitable. The addition of the second comonomer (b1c) makes it possible to prepare, in particular, polyoxymethylene (POM) terpolymers.

The second comonomer (b1c) is preferably selected from the group consisting of a compound of formula (III) and a compound of formula (IV),

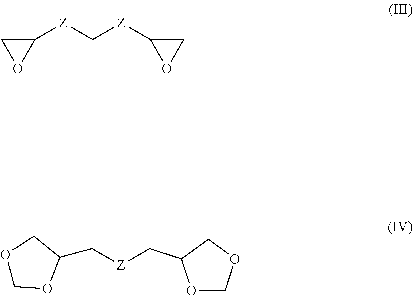

wherein
Z is selected from the group consisting of a chemical bond, an (—O—) group and an (—O—R⁶—O—) group,
   wherein
R⁶ is selected from the group consisting of unsubstituted C₁-C₈-alkylene and C₃-C₈-cycloalkylene.

Within the context of the present invention, definitions such as C₁-C₈-alkylene means C₁-C₈-alkanediyl. The C₁-C₈-alkylene is a hydrocarbon having two free valences and a carbon atom number of from 1 to 8. The C₁-C₈-alkylene can be branched or unbranched.

Within the context of the present invention, definitions such as C₃-C₈-cycloalkylene means C₃-C₈-cycloalkanediyl. A C₃-C₈-cycloalkylene is a cyclic hydrocarbon having two free valences and a carbon atom number of from 3 to 8. Hydrocarbons having two free valences, a cyclic and also a linear component, and a carbon atom number of from 3 to 8 likewise fall under this definition.

Preferred examples of the second comonomer (b1c) are ethylene diglycidyl, diglycidyl ether and diethers prepared from glycidyl compounds and formaldehyde, dioxane or trioxane in a molar ratio of 2:1 and likewise diethers prepared from 2 mol of a glycidyl compound and 1 mol of an aliphatic diol having from 2 to 8 carbon atoms, for example the diglycidyl ether of ethylene glycol, 1,4-butanediol, 1,3-butanediol, 1,3-cyclobutanediol, 1,2-propanediol and 1,4-cyclohexanediol.

In a preferred embodiment, component (b1) is a polyoxymethylene (POM) copolymer which is prepared by polymerization of from at least 50 mol-% of a formaldehyde source (b1a), from 0.01 to 20 mol-% of at least one first comonomer (b1b) and from 0 to 20 mol-% of at least one second comonomer (b1c).

In a particularly preferred embodiment component (b1) is a polyoxymethylene (POM) copolymer which is prepared by polymerization of from 80 to 99.98 mol-%, preferably from 88 to 99 mol-% of a formaldehyde source (b1a), from 0.1 to 10 mol-%, preferably from 0.5 to 6 mol-% of at least one first comonomer (b1b) and from 0.1 to 10 mol-%, preferably from 0.5 to 6 mol-% of at least one second comonomer (b1c).

In a further preferred embodiment component (b1) is a polyoxymethylene (POM) copolymer which is prepared by polymerization of from at least 50 mol-% of a formaldehyde source (b1a), from 0.01 to 20 mol-% of at least one first comonomer (b1b) of the general formula (II) and from 0 to 20 mol-% of at least one second comonomer (b1c) selected from the group consisting of a compound of formula (III) and a compound of formula (IV).

In a preferred embodiment of the process according to the invention, in the filament the polymer (P) in component (b1) is a polyoxymethylene (POM) copolymer which is prepared by polymerization of
from at least 50 mol-% of a formaldehyde source (b1a),
from 0.01 to 20 mol-% of at least one first comonomer (b1b) of the general formula (II)

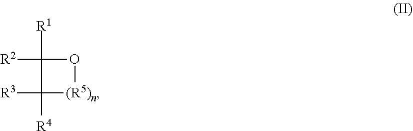

wherein
R¹ to R⁴ are each independently of one another selected from the group consisting of H, C₁-C₄-alkyl and halogen-substituted C₁-C₄-alkyl;
R⁵ is selected from the group consisting of a chemical bond, a (—CR^{5a}R^{5b}—) group and a (—CR^{5a}R^{5b}O—) group,
   wherein
R^{5a} and R^{5b} are each independently of one another selected from the group consisting of H and unsubstituted or at least monosubstituted C₁-C₄-alkyl,
   wherein the substituents are selected from the group consisting of F, Cl, Br, OH and C₁-C₄-alkyl;
n is 0, 1, 2 or 3;
   and
   from 0 to 20 mol-% of at least one second comonomer (b1c) selected from the group consisting of a compound of formula (III) and a compound of formula (IV)

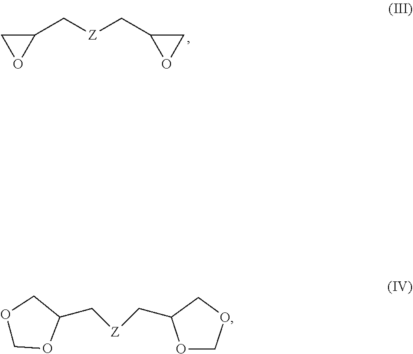

wherein
Z is selected from the group consisting of a chemical bond, an (—O—) group and an (—O—R⁶—O—) group,
   wherein
R⁶ is selected from the group consisting of unsubstituted C₁-C₈-alkylene and C₃-C₈-cycloalkylene.

In a preferred embodiment of the present invention, at least some of the OH-end groups of the polyoxymethylene (POM) are capped. Methods for capping OH-end groups are known to the skilled person. For example, the OH-end groups can be capped by etherification or esterification.

Preferred polyoxymethylene (POM) copolymers have melting points of at least 150° C. and weight average molecular weights M_{w} in the range from 5 000 g/mol to 300 000 g/mol, preferably from 6 000 g/mol to 150 000 g/mol, particularly preferably in the range from 7 000 g/mol to 100 000 g/mol.

Particular preference is given to polyoxymethylene (POM) copolymers having a polydispersity (M_{w}/Mₙ) of from 2 to 15, preferably from 2.5 to 12, particularly preferably from 3 to 9.

The measurement of the weight-average molecular weight (M_{w}) and the number-average molecular weight (Mₙ) is generally carried out by gel permeation chromatography (GPC). GPC is also known as sized exclusion chromatography (SEC).

Methods for the preparation of polyoxymethylene (POM) are known to those skilled in the art.

Further, the binder (B) may comprise a component (b2).

Preferably, the binder (B) comprises from 2 to 35% by weight, more preferably 3 to 20% by weight, most preferably 4 to 15% by weight of component (b2).

Preferably component (b2) is at least one polyolefin (PO). “At least one polyolefin (PO)” within the present invention means precisely one polyolefin (PO) and also mixtures of two or more polyolefins (PO).

Polyolefins (PO) are known per se and are commercially available. They are usually prepared by polymerization of C₂-C₈-alkene monomers, preferably by polymerization of C₂-C₄-alkene monomers.

Within the context of the present invention, C₂-C₈-alkene means unsubstituted or at least monosubstituted hydrocarbons having 2 to 8 carbon atoms and at least one carbon-carbon double bond (C—C-double bond). “At least one carbon-carbon double bond” means precisely one carbon-carbon double bond and also two or more carbon-carbon double bonds.

In other words, C₂-C₈-alkene means that the hydrocarbons having 2 to 8 carbon atoms are unsaturated. The hydrocarbons may be branched or unbranched. Examples for C₂-C₈-alkenes with one C—C-double bond are ethene, propene, 1-butene, 2-butene, 2-methyl-propene (=isobutylene), 1-pentene, 2-pentene, 2-methyl-1-butene, 3-methyl-1-butene, 1-hexene, 2-hexene, 3-hexene and 4-methyl-1-pentene. Examples for C₂-C₈-alkenes having two or more C—C-double bonds are allene, 1,3-butadiene, 1,4-pentadiene, 1,3-pentadiene, 2-methyl-1,3-butadiene (=isoprene).

If the C₂-C₈-alkenes have one C—C-double bond, the polyolefins (PO) prepared from those monomers are linear. If more than one double bond is present in the C₂-C₈-alkenes, the polyolefins (PO) prepared from those monomers can be crosslinked. Linear polyolefins (PO) are preferred.

It is also possible to use polyolefin (PO) copolymers, which are prepared by using different C₂-C₈-alkene monomers during the preparation of the polyolefins (PO).

Preferably, the polyolefins (PO) are selected from the group consisting of polymethylpentene, poly-1-butene, polyisobutylene, polyethylene and polypropylene. Particular preference is given to polyethylene and polypropylene and also their copolymers as are known to those skilled in the art and are commercially available.

The polyolefins (PO) can be prepared by any polymerization process known to the skilled person, preferably by free radical polymerization, for example by emulsion, bead, solution or bulk polymerization. Possible initiators are, depending on the monomers and the type of polymerization, free radical initiators such as peroxy compounds and azo compounds with the amounts of initiator generally being in the range from 0.001 to 0.5% by weight, based on the monomers.

The binder (B) may comprise a further polymer (FP) as component (b3).

The terms “component (b3)” and “further polymer (FP)” for the purpose of the present invention are synonymous and are used interchangeably throughout the present invention.

Preferably, the binder (B) comprises 2 to 40% by weight, more preferably 5 to 30% by weight, most preferably 10 to 26% by weight, based on the total weight of the binder (B), as component (b3).

Component (b3) is at least one further polymer (FP). “At least one further polymer (FP)” within the present invention means precisely one further polymer (FP) and also mixtures of two or more further polymers (FP).

As already stated above, the at least one further polymer (FP) differs from component (b1), the polyoxymethylene (POM), and component (b2), the polyolefin (PO).

The at least one further polymer (FP) preferably is at least one further polymer (FP) selected from the group consisting of a polyether, a polyurethane, a polyepoxide, a polyamide, a vinyl aromatic polymer, a poly(vinyl ester), a poly(vinyl ether), a poly(alkyl(meth)acrylate) and copolymers thereof.

Preferably, component (b3), the at least one further polymer (FP), is selected from the group consisting of a poly(C₂-C₆-alkylene oxide), an aliphatic polyurethane, an aliphatic uncrosslinked epoxide, an aliphatic polyamide, a vinyl aromatic polymer, a poly(vinyl ester) of an aliphatic C₁-C₈ carboxylic acid, a poly(vinyl ether) of a C₁-C₈ alkyl vinyl ether, a poly(alkyl(meth)acrylate) of a C₁₋₈-alkyl and copolymers thereof.

Preferred at least one further polymers (FP) are described in more detail below.

Polyethers comprise repeating units of formula (V).

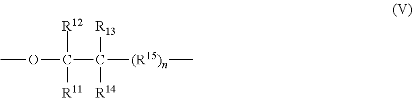

R¹¹ to R¹⁴ are each independently of one another selected from the group consisting of H, C₁-C₄-alkyl and halogen-substituted C₁-C₄-alkyl;
R¹⁵ is selected from the group consisting of a chemical bond, a (—CR^{15a}R^{15b}—) group and a (—CR^{15a}R^{15b}O—) group,
   wherein
R^{15a} and R^{15b} are each independently of one another selected from the group consisting of H and unsubstituted or at least monosubstituted C₁-C₄-alkyl,
   wherein the substituents are selected from the group consisting of F, CI, Br, OH and C₁-C₄-alkyl;
n is 0, 1, 2 or 3.

If n is 0, then R¹⁵ is a chemical bond between the adjacent carbon atom and the oxygen atom. If R¹⁵ is a (—CR^{15a}R^{15b}O—) group, then the oxygen atom (O) of the (—CR^{15a}R^{15b}O—) group is bound to another carbon atom (C) of formula (V) and not to the oxygen atom (O) of formula (V). In other words, formula (V) does not comprise peroxide compounds. The same holds true for formula (VI).

Typical polyethers as well as their preparation are known to the skilled person.

A preferred polyether is, for example, a poly(alkylene glycol), also known as a poly(alkylene oxide).

Polyalkylene oxides and their preparation are known to the skilled person. They are usually synthesized by interaction of water and a bi- or polyvalent alcohol with cyclic ethers, i. e. alkylene oxides, of the general formula (VI). The reaction is catalyzed by an acidic or basic catalyst. The reaction is a so called ring-opening polymerization of the cyclic ether of the general formula (VI).

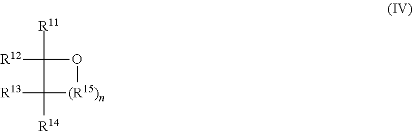

wherein
R¹¹ to R¹⁵ have the same meanings as defined above for formula (V).

A preferred poly(alkylene oxide) is derived from monomers of the general formula (VI) having 2 to 6 carbon atoms in the ring. In other words, preferably, the poly(alkylene oxide) is a poly(C₂-C₆-alkylene oxide). Particular preference is given to a poly(alkylene oxide) derived from monomers selected from the group consisting of 1,3-dioxolane, 1,3-dioxepane and tetrahydrofuran (IUPAC-name: oxolane). In other words, particularly 15 preferably, the poly(alkylene oxide) is selected from the group consisting of poly-1,3-dioxolane, poly-1,3-dioxepane and polytetrahydrofuran.

In one embodiment, the poly(alkylene oxide) can comprise OH-end groups. In another embodiment, at least some of the OH-end groups of the poly(alkylene oxide) can be capped. Methods for capping OH-end groups are known to the skilled person. For example, the OH-end groups can be capped by etherification or esterification.

The weight average molecular weight of the poly(alkylene oxide) is preferably in the range of from 1 000 to 150 000 g/mol, particular preferably from 1 500 to 120 000 g/mol and more preferably in the range of from 2 000 to 100 000 g/mol.

A polyurethane is a polymer having carbamate units. Polyurethanes as well as their preparation is known to the skilled person.

Within the present invention, aliphatic polyurethanes are preferred. They can, for example, be prepared by polyaddition of aliphatic polyisocyanates and aliphatic polyhydroxy compounds. Among the polyisocyanates, diisocyanates of the general formula (VII) are preferred

OCN—R⁷—NCO (VII),

wherein
R⁷ is a substituted or unsubstituted C₁-C₂₀-alkylene or C₄-C₂₀-cycloalkylene, wherein the substituents are selected from the group consisting of F, Cl, Br and C₁-C₆-alkyl.

Preferably R⁷ is a substituted or unsubstituted C₂₋C₁₂-alkylene or C₆-C₁₅-cycloalkylene.

Within the context of the present invention, definitions such as C₁-C₂₀-alkylene means C₁-C₂₀-alkanediyle. The C₁-C₂₀-alkylene is a hydrocarbon having two free valences and a carbon atom number of from 1 to 20. The C₁-C₂₀-alkylene can be branched or unbranched.

Within the context of the present invention, definitions such as C₄-C₂₀-cycloalkylene means C₄-C₂₀-cycloalkanediyle. A C₄-C₂₀-cycloalkylene is a cyclic hydrocarbon having two free valences and a carbon atom number of from 4 to 20. Hydrocarbons having two free valences, a cyclic and also a linear component and a carbon atom number of from 4 to 20 likewise fall under this definition.

Preferred diisocyanates are selected from the group consisting of hexamethylenediisocyanate, 2,2,4-trimethyl hexamethylenediisocyanate, 2,4,4-tri-methyl hexamethylenediisocyanate, 1,2-diisocyanatomethyl cyclohexane, 1,4-diisocyanatomethyl cyclohexane and isophorondiisocyanate (IUPAC-name: 5-isocyanato-1-(isocyanatomethyl)-1,3,3-trimethyl-cyclohexane).

The diisocyanates may also be used in oligomeric, for example dimeric or trimeric form. Instead of the polyisocyanates, it is also possible to use conventional blocked polyisocyanates which are obtained from the stated isocyanates, for example by an addition reaction of phenol or caprolactam.

Suitable polyhydroxy compounds for the preparation of aliphatic polyurethanes are, for example, polyesters, polyethers, polyesteramides or polyacetales or mixtures thereof.

Suitable chain extenders for the preparation of the polyurethanes are low molecular weight polyols, in particular diols and polyamines, in particular diamines or water.

The polyurethanes are preferably thermoplastic and therefore preferably essentially uncrosslinked, i. e. they can be melted repeatedly without significant signs of decomposition. Their reduced specific viscosities are as a rule from 0.5 to 3 dl/g, preferably from 1 to 2 dl/g measured at 30° C. in dimethylformamide.

A polyepoxide comprises at least two epoxide groups. The epoxide groups are also known as glycidyl or oxirane groups. “At least two epoxide groups” mean precisely two epoxide groups and also three or more epoxide groups.

Polyepoxides and their preparation is known to the person skilled in the art. For example, polyepoxides are prepared by the reaction of epichlorhydrine (IUPAC-name: chlormethyloxirane) and a diol, a polyol or a dicarboxylic acid. Polyepoxides prepared in this way are polyethers having epoxide end groups.

Another possibility to prepare polyepoxides is the reaction of glycidyl(meth)acrylate (IUPAC-name: oxiran-2-ylmethyl-2-methylprop-2-enoate) with polyolefins or polyacrylates. This results in polyolefins or polyacrylates having epoxy end groups.

Preferably, aliphatic uncrosslinked polyepoxides are used. Copolymers of epichlorhydrine and 2,2-bis-(4-hydroxyphenyl)-propane (bisphenol A) are particularly preferred.

Component (b3) (the at least one further polymer (FP)) can also comprise a polyamide. Aliphatic polyamides are preferred.

The intrinsic viscosity of suitable polyamides is generally from 150 to 350 ml/g, preferably from 180 to 275 ml/g. Intrinsic viscosity is determined here from a 0.5% by weight solution of the polyamide in 96% by weight sulfuric acid at 25° C. in accordance with ISO 307.

Preferred polyamides are semicrystalline or amorphous polyamides.

Examples of polyamides suitable as component (b3) are those that derive from lactams having from 7 to 13 ring members. Other suitable polyamides are those obtained through reaction of dicarboxylic acids with diamines.

Examples that may be mentioned of polyamides that derive from lactams are polyamides that derive from polycaprolactam, from polycaprylolactam, and/or from polylaurolactam.

If polyamides are used that are obtainable from dicarboxylic acids and diamines, dicarboxylic acids that can be used are alkanedicarboxylic acids having from 6 to 14 carbon atoms, preferably from 6 to 10 carbon atoms. Aromatic dicarboxylic acids are also suitable.

Examples that may be mentioned here as dicarboxylic acids are adipic acid, azelaic acid, sebacic acid, dodecanedicarboxylic acid, and also terephthalic acid and/or isophthalic acid.

Examples of suitable diamines are alkanediamines, having from 4 to 14 carbon atoms, in particular alkanediamines having from 6 to 8 carbon atoms, and also aromatic diamines, for example m-xylylenediamine, di(4-aminophenyl)methane, di(4-aminocyclohexyl)methane, 2,2-di(4-aminophenyl)propane, 2,2-di(4-aminocyclohexyl)-propane, and 1,5-diamino-2-methylpentane.

Other suitable polyamides are those obtainable through copolymerization of two or more of the monomers mentioned above and mentioned below, and mixtures of a plurality of polyamides in any desired mixing ratio.

Preferred polyamides are polyhexamethyleneadipamide, polyhexamethylene-sebacamide, and polycaprolactam, and also nylon-6/6,6, in particular having a proportion of from 75 to 95% by weight of caprolactam units.

Particular preference is given to mixtures of nylon-6 with other polyamides, in particular with nylon-6/6,6 (PA 6/66), particular preference being given to mixtures of from 80 to 50% by weight of PA 6 and from 20 to 50% by weight of PA 6/66, where the PA 6/66 comprises from 75 to 95% by weight of caprolactam units, based on the total weight of the PA 6/66 in the mixture.

The following, non-exclusive list comprises the abovementioned polyamides, and other suitable polyamides, and also the monomers comprised.

AB Polymers:
PA 4 Pyrrolidone
PA 6 ε-Caprolactam
PA 7 Ethanolactam
PA 8 Caprylolactam
PA 9 9-Aminopelargonic acid
PA 11 11-Aminoundecanoic acid
PA 12 Laurolactam

AA/BB Polymers:
PA 46 Tetramethylenediamine, adipic acid
PA 66 Hexamethylenediamine, adipic acid
PA 69 Hexamethylenediamine, azelic acid
PA 610 Hexamethylenediamine, sebacic acid
PA 612 Hexamethylenediamine, decanedicarboxylic acid
PA 613 Hexamethylenediamine, undecanedicarboxylic acid
PA 1212 1,12-Dodecanediamine, decanedicarboxylic acid
PA 1313 1,13-Diaminotridecane, undecanedicarboxylic acid
PA 6T Hexamethylenediamine, terephthalic acid
PA MXD6 m-Xylylenediamine, adipic acid
PA 6I Hexamethylenediamine, isophthalic acid
PA 6-3-T Trimethylhexamethylenediamine, terephthalic acid
PA 6/6T (see PA 6 and PA 6T)
PA 6/66 (see PA 6 and PA 66)
PA 6/12 (see PA 6 and PA 12)
PA 66/6/610 (see PA 66, PA 6 and PA 610)
PA 6I/6T (see PA 6I and PA 6T)
PA PACM 6 Diaminodicyclohexylmethane, adipic acid
PA PACM 12 Diaminodicyclohexylmethane, laurolactam
PA 6I/6T/PACM as PA 6I/6T+diaminodicyclohexylmethane
PA 9T 1,9-Nonanediamine, terephthalic acid
PA 12/MACMl Laurolactam, dimethyldiaminodicyclohexylmethane, isophthalic acid
PA 12/MACMT Laurolactam, dimethyldiaminodicyclohexylmethane, terephthalic acid
PA PDA-T Phenylenediamine, terephthalic acid

Preferred polyamides are PA 6, PA 66 and PA PACM 6.

Vinyl aromatic polymers are polyolefins having unsubstituted or at least monosubstituted styrene as monomer unit. Suitable substituents are, for example, C₁-C₆-alkyls, F, Cl, Br and OH. Preferred vinyl aromatic polymers are selected from the group consisting of polystyrene, poly-α-methylstyrene and copolymers thereof with up to 30% by weight of comonomers selected from the group consisting of acrylic esters, acrylonitrile and methacrylonitrile.

Vinyl aromatic polymers are commercially available and known to the person skilled in the art. The preparation of these polymers is also known to the person skilled in the art.

Preferably, the vinyl aromatic polymers are prepared by free radical polymerization, for example by emulsion, bead, solution or bulk polymerization. Possible initiators are, depending on the monomers and the type of polymerization, free radical initiators such as peroxide compounds and azo compounds with the amounts of initiator generally being in the range from 0.001 to 0.5% by weight, based on the monomers.

Poly(vinyl esters) and their preparation are known to the skilled person. Poly(vinyl esters) are preferably prepared by polymerization of vinyl esters. In a preferred embodiment of the present invention, the vinyl esters are vinyl esters of aliphatic C₁-C₆ carboxylic acids. Preferred monomers are vinyl acetate and vinyl propionate. These monomers form poly(vinyl acetate) and poly(vinyl propionate) polymers.

Poly(vinyl ethers) are prepared by polymerization of vinyl ether monomers. Poly(vinyl ethers) and their preparation are known to the skilled person. In a preferred embodiment, the vinyl ethers are vinyl ethers of aliphatic C₁-C₈ alkyl ethers. Preferred monomers are methyl vinyl ether and ethyl vinyl ether, forming poly(methyl vinyl ether) and poly(ethyl vinyl ether) during the polymerization.

Preferably, the poly(vinyl ethers) are prepared by free radical polymerization, for example by emulsion, bead, solution, suspension or bulk polymerization. Possible initiators are, depending on the monomers and the type of polymerization, free radical initiators such as peroxide compounds and azo compounds with the amounts of initiator generally being in the range from 0.001 to 0.5% by weight, based on the monomers.

Poly(alkyl(meth)acrylate) within the present invention comprises poly(alkyl acrylate), poly(alkyl methacrylates) and copolymers thereof. Poly(alkyl(meth)acrylate) comprises units derived from monomers of formula (VIII),

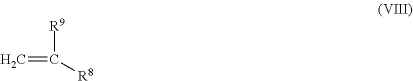

wherein
R⁸ is selected from the group consisting of H and C₁-C₈-alkyl and
R⁹ is a radical of formula (IX)

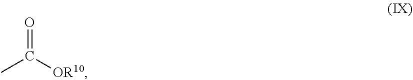

wherein
R¹⁰ is a C₁-C₁₄-alkyl.

Preferably, R⁸ is selected from the group consisting of H and C₁-C₄-alkyl, particularly preferably R⁸ is H or methyl. Preferably, R¹⁰ is a C₁-C₈-alkyl, particularly preferably, R¹⁰ is methyl or ethyl.

If R⁸ in formula (VIII) is H and R⁹ is a radical of formula (IX) and R¹⁰ in formula (IX) is methyl, then the monomer of formula (VIII) is methyl acrylate.

If R⁸ in formula (VIII) is H and R⁹ is a radical of formula (IX) and R¹⁰ in formula (IX) is ethyl, the monomer of formula (VIII) is ethyl acrylate.

If R⁸ in formula (VIII) is methyl and R⁹ is a radical of formula (IX), then the monomers of formula (VI) are methacrylic esters.

Poly(alkyl(meth)acrylates) comprise as monomers preferably 40 to 100% by weight of methacrylic esters, particularly preferably 70 to 100% by weight of methacrylic esters and more preferably from 80 to 100% by weight of methacrylic esters, each based on the total amount of the poly(alkyl(meth)acrylates).

In another preferred embodiment, the poly(alkyl(meth)acrylates) comprise as monomers from 20 to 100% by weight of methyl acrylate, ethyl acrylate or a mixture thereof, preferably from 40 to 100% by weight of methyl acrylate, ethyl acrylate or a mixture thereof and particularly preferably from 50 to 100% by weight of methyl acrylate, ethyl acrylate or mixtures of thereof, each based on the total weight of the poly(alkyl (meth)acrylate).

Such polymers of monomers of the formula (VIII) with or without further monomers can be prepared in a conventional, preferably a free radical polymerization, for example an emulsion, bead, solution or bulk polymerization (cf. Kirk-Othmer, Encyclopedia of Chemical Technology 3^{rd} Ed., Vol. 1., pp. 330-342, Vol. 18, pp. 720-755, J. Wiley; H. Rauch-Puntigam, Th. Völker, Acryl-aud Methacrylverbindungen). Possible initiators depending on the monomers and the type of polymerization are free radical initiators, such as peroxy or peroxo compounds and azo compounds. The amount of initiator being in general within the range from 0.001 to 0.5% by weight, based on the monomers.

Suitable initiators for an emulsion polymerization are, for example, peroxodisulfates and redox systems for a bulk polymerization not only peroxides, such as dibenzoyl peroxide or dilauroyl peroxide, but also azo compounds, for example azobisisobutyrodinitrile, similarly in the case of the solution or bead polymerization. The molecular weight may be regulated using conventional regulators, in particular mercaptans, e. g. dodecylmercaptan.

Preferably, the polymerization is carried out at elevated temperatures, for example above 50° C. The weight average molecular weight (M_{w}) is in general within the range of from 2 000 to 5 000 000 g/mol, preferably from 20 000 to 3 000 000 g/mol (determination by light scattering; cf. HoubenWeyl, Methoden der Org. Chemie, 4^{th} edition, Volume 14/1, Georg Thieme-Verlag Stuttgart 1961).

The person skilled in the art knows that the monomers described above for the preparation of the components (b1), (b2) and (b3) can undergo changes in their structure during the polymerization reaction. Consequently, the building units of the polymers are not the same as the monomers from which they are derived. However, the person skilled in the art knows which monomers correspond to which building unit of the polymers.

Under the conditions of compounding or processing by fused filament fabrication, virtually no transacetalization occurs between component (b1), the polyoxymethylene (POM), and component (b3), the at least one further polymer (FP), i. e. virtually no exchange of comonomer units takes place.

In one embodiment of the invention the binder (B) in the core material (CM) comprises, besides (b1), the components (b2) and/or (b3).

In a preferred embodiment, the binder (B) comprises besides (b1), 2 to 35% by weight of component (b2), based on the total weight of the binder (B), and/or from 2 to 40% by weight of component (b3), based on the total weight of the binder (B).

In another embodiment of the invention the binder (B) comprises, besides (b1), the components (b2) and/or (b3), wherein
(b2) is at least one polyolefin (PO) and
(b3) is at least one further polymer (FP), in case the at least one polymer (P) in component (b) is a polyoxymethylene (POM).

The core material (CM) comprises as component (c) 0 to 20% by volume, preferably 1.5 to 15% by volume, more preferably 2 to 10% by volume, based on the total volume of the core material (CM) of the at least one additive (A).

As component (c), at least one additive (A) can be used. “At least one additive (A)” within the context of the present invention means precisely one additive (A) and also mixtures of two or more additives (A).

The additive (A) can be selected from among known dispersants. Examples are oligomeric polyethylene oxide having a low molecular weight of from 200 to 600 g/mol stearic acid, stearamides, hydroxystearic acids, fatty alcohols, fatty alcohol, fatty acid esters, sulfonates and block copolymers of ethylene oxide and propylene oxide and also, particularly preferably, polyisobutylene.

Further, the additive (A) may be selected from stabilizers, like UV-stabilizers and/or antioxidants.

The additive (A) may be selected from pigments, such as organic dyes and/or inorganic pigments.

The additive (A) may be selected from tackifiers, like polymers with a glass transition temperature below room temperature, which is preferably below 25° C. and/or terpene derivatives.

The additive (A) may also be selected from the tackifiers as disclosed in WO 2013/117428 A1. An example for a commercially available tackifier is Acronal® A107.

Based on WO 2013/117428 A1 and applying the definitions of the components of the tackifiers in WO 2013/117428 A1, as tackifiers preferably dispersions are applied comprising at least one in water soluble dispersed polymerisate with a weighted average molecular weight of less than 50 000 g/mol and a glass transition temperature higher or equal to −40° C. to lower or equal 0° C., preferably higher or equal −35° C. or equal 0° C., preferable of a monomer mixture comprising
(c1a) at least 40% by weight of at least one C1 to C20-alkyl (meth)acrylate
(c1b) 0 to 30% by weight of at least one vinyl aromate
(c1c) at least 0.1% by weight of at least one acid monomer
(c1d) 0 to 50% by weight of further monomers,
   wherein the amounts of the monomers are based on the sum of all monomers.

Furthermore, tackifiers may be applied as disclosed in U.S. Pat. No. 4,767,813 and as specified in the following three paragraphs.

According to U.S. Pat. No. 4,767,813, the tackifier may be rosin or a derivative of rosin having a ring and ball softening temperature from about 25° to 110° C., preferably from about 50° to 110° C.

Suitable tackifiers include rosin, hydrogenated rosin esters, glycerol of rosin such as triglycerol rosin esters, C₂₋₃ alkylene esters of rosin such as triethylene glycol esters of rosin and tripropylene glycol esters of rosin; rosin salts, disproportionated rosin salts, pentaerythritol and the polyterpene resins including alpha and beta pinene. Suitable resins are sold under the tradenames Staybelite Ester 3, Staybelite Ester 10, Pentalyn H and Hercolyn D.

The tackifier resin may be a C₅ or C₉ synthetic tackifier resin having a ring and ball 10 softening point from about 10° to 100° C., preferably from about 50° to 100° C. Suitable resins are sold under the tradenames Piccovar, Hercotac, Picconal and Piccolyte. These tackifiers are polymerized from C₉ monomers, preferably aromatic and C₅ monomers, preferably aliphatic.

The shell material (SM) comprises the components (d) to (f).

Component (d) comprises 75 to 100% by volume, preferably 85 to 100% by volume, more preferably 95 to 100% by volume, based on the total volume of the shell material (SM) of at least one thermoplastic polymer (TP).

As thermoplastic polymer (TP), the person skilled in the art may select any technical appropriate thermoplastic polymer.

The thermoplastic polymer (TP) may also be identical with one of the polymers used in the binder (B) of the core material (CM).

“At least one thermoplastic polymer (TP)” within the present invention means precisely one thermoplastic polymer (TP) and also mixtures of two or more thermoplastic polymers (TP).

The at least one thermoplastic polymer (TP) may comprise thermoplastic homopolymers, thermoplastic copolymers, as well as blends of thermoplastic polymers.

Preferably, the thermoplastic polymer (TP) is selected from the group of polyoxymethylene (POM), polyolefins (PE) such as polypropylene, polyurethanes (PU), polyamides (PA), polyethers (PETH), polycarbonates (PC), and/or polyesters (PES), such as polylactic acid and blends thereof.

More preferably the thermoplastic polymer (TP) is selected from the group of polyoxymethylene (POM), polypropylene and/or polylactic acid (PLA) and blends thereof. Component (e) consists of 0 to 20% by volume, based on the total volume of the shell material (SM), of the at least one inorganic powder (IP).

The at least one inorganic powder (IP) in the component (e) is identical to the inorganic powder (IP) as defined for the component (a) in the core material (CM).

Preferably, the shell material (SM) does not contain any of the at least one inorganic powder (IP) according to component (e).

However, in the embodiment of the invention wherein the shell material (SM) does not contain any of the at least one inorganic powder (IP), there may be traces of inorganic powder (IP) present in the shell material (SM) of less than 1% by volume, based on the total volume of the shell material (SM).

Component (f) comprises 0 to 25% by volume, preferably 0 to 15% by volume, more preferably 0 to 5% by volume, based on the total weight of the shell material (SM) of the at least one additive (A).

The at least one additive (A) in the component (f) is selected from the same compounds as the additive (A) in the component (c). The at least one additive (A) of component (f) or the combination of additives (A) in component (f) may differ individually from the at least one additive (A) of component (c) or combination of additives (A) of component (c) or be the same in a single embodiment of the invention.

In one embodiment of the invention the core material (CM) comprises the components (a), (b) and (c)
(a) 30 to 80% by volume, preferably 40 to 68% by volume, more preferably 50 to 65% by volume, based on the total volume of the core material (CM), of at least one inorganic powder (IP),
(b) 20 to 70% by volume, preferably 20 to 60% by volume, more preferably 20 to 50% by volume based on the total volume of the core material (CM) of the at least one binder (b) comprising component (b1)
(b1) at least one polymer (P)
(c) 0 to 20% by volume, preferably 1.5 to 15% by volume, more preferably 2 to 10% by volume, based on the total volume of the core material (CM) of the at least one additive (A),
   and the shell material (SM) comprises the components (d) to (f)
(d) 75 to 100% by volume, based on the total weight of the shell material (SM) of at least one thermoplastic polymer (TP)
(e) 0 to 20% by volume, based on the total volume of the shell material (SM) of the at least one inorganic powder (IP),
(f) 0 to 25% by volume, preferably 0 to 10% by volume, more preferably 0 to 5% by volume, most preferably 0 to 3% by volume, based on the total volume of the shell material (SM) of the at least one additive (A),
   wherein the thickness of the layer of shell material (SM) is 0.05 to 0.5 mm, preferably 0.09 to 0.3 mm, more preferably 0.1 to 0.25 mm.

In another embodiment of the invention the core material (CM) comprises the components (a) and (b)
(a) 30 to 80% by volume, preferably 40 to 68% by volume, more preferably 50 to 65% by volume,based on the total volume of the core material (CM),of at least one inorganic powder (IP),
(b) 20 to 70% by volume, 20 to 60% by volume, more preferably 20 to 50% by volume based on the total volume of the core material (CM) of the at least one binder (B) comprising component (b1)
(b1) at least one polymer (P)
(c) 0 to 20% by volume, preferably 1.5 to 15% by volume, more preferably 2 to 10% by volume, based on the total volume of the core material (CM) of the at least one additive (A),
   and the shell material (SM) comprises the component (d)
(d) 100% by volume, based on the total weight of the shell material (SM) of at least one thermoplastic polymer (TP)
(e) 0% by volume, based on the total volume of the shell material (SM) of the at least one inorganic powder (IP),
(f) 0% by volume, based on the total volume of the shell material (SM) of the at least one additive (A).

In a further embodiment, of the invention the core material (CM) comprises the components (a) and (b)
(a) 30 to 80% by volume, preferably 40 to 68% by volume, more preferably 50 to 65% by volume,based on the total volume of the core material (CM),of at least one inorganic powder (IP),
(b) 20 to 70% by volume, 20 to 60% by volume, more preferably 20 to 50% by volume based on the total volume of the core material (CM) of the at least one binder (B) comprising component (b1)
(b1) at least one polymer (P)
(c) 0 to 20% by volume, preferably 1.5 to 15% by volume, more preferably 2 to 10% by volume, based on the total volume of the core material (CM) of the at least one additive (A),
   and the shell material (SM) comprises the component (d)
(d) 100% by volume, based on the total weight of the shell material (SM) of at least one thermoplastic polymer (TP)
(e) 0% by volume, based on the total volume of the shell material (SM) of the at least one inorganic powder (IP),
(f) 0% by volume, based on the total volume of the shell material (SM) of the at least one additive (A),
   wherein the thickness of the layer of shell material (SM) is 0.05 to 0.5 mm, preferably 0.09 to 0.3 mm, more preferably 0.1 to 0.25 mm.

The at least one filament to be employed in the process according to the invention is usually prepared by coating a core material (CM) with a layer of a shell material (SM) by co-extrusion of the core material (CM) with the shell material (SM). The co-extrusion technique as such is known to the person skilled in the art. Based on the applied materials for the core material (CM) and the shell material (SM), the person skilled in the art my choose the respective appropriate co-extrusion temperatures and process parameters. A process for the production of filaments to be employed in the process according to the invention is, for example, disclosed in more detail in PCT/EP2016/066187.

Within the process according to the present invention, the three-dimensional green body is produced by a fused filament fabrication process, employing a three-dimensional extrusion printer (3D printer). For the purposes of the present invention, the terms “three-dimensional extrusion printer” and “3D printer” are synonymous and are used interchangeably.

The design of a three-dimensional extrusion printer and the relevant process parameters are, for example, described in U.S. Pat. No. 5,121,329. The person skilled in the art may make appropriate use of these parameters in all embodiments of extrusion-based 3D printing processes related to the present invention.

According to the invention, the three-dimensional extrusion printer contains at least one nozzle and at least one mixing element. The three-dimensional extrusion printer preferably contains at least one printhead containing the at least one nozzle and the at least one mixing element. For the purposes of the present invention, the term “printhead” means the entire device for the conveying, melting and application of a filament in an extrusion-based 3D printing process.

For the purposes of the present invention, the term “at least one nozzle” is understood to mean exactly one nozzle as well as two or more nozzles. If two or more nozzles are used, the nozzles can be identical or different. Different types of nozzles can be used depending on the three-dimensional green body to be formed.

The variation of the extrusion diameter of the nozzle directly influences the degree of detail in the three-dimensional green body. For example, using nozzles with very small extrusion diameters allows for the three-dimensional green body to be created with very fine detail, whereas less detail can be achieved using nozzles with larger extrusion diameters. Nozzles with larger extrusion diameter, however, usually have the advantage of higher production speeds. The person skilled in the art will choose the extrusion diameter of the at least one nozzle according to the requirements of the three-dimensional body.

The at least one nozzle can generally be of any form or size, depending on the process in which it is used. Preferably, the nozzle has a cylindrical shape.

Preferably, the at least one nozzle has an extrusion diameter<1.5 mm, preferably <0.8 mm. The resolution of the three-dimensional green body is usually proportional to the nozzle diameter.

The nozzle feed diameter is preferably in the range of 1 mm to 10 mm, more preferably in the range of from 2 mm to 7.5 mm, even more preferably in the range of from 2.5 mm to 6.5 mm and especially preferably in the range of from 3 mm to 6 mm. Within the context of the present invention, the term “nozzle feed diameter” is understood to mean the diameter between the inner walls of the cross-section of the at least one nozzle.

The nozzle length can also vary greatly depending on the intended application and can be in the range of 1.5 cm to 20 cm, preferably in the range of 2 cm to 10 cm and more preferably in the range of 2.5 cm to 5 cm.

The at least one nozzle is preferably heated so that the filament is present within the at least one nozzle in molten form, for example the at least one nozzle is heated by electric heaters. The heat of the electric heaters in the at least one nozzle is preferably isolated, so that the filament does not soften prior to reaching the at least one nozzle.

The at least one nozzle thus, preferably has at least two regions, with the filament being in solid form in the first region and the filament being present in molten form in the second region of the at least one nozzle. Within the at least one nozzle, the transition between the solid condition and the molten condition of the filament is continuous.

According to the invention, the 3D printer contains at least one mixing element. In general, various embodiments of mixing elements are conceivable. Suitable mixing elements are known from the prior art. Suitable mixing elements are all mixers which are suitable for the mixing of molten filaments and are sufficiently well-known to those skilled in the art. They are selected according to the process technology requirements.

The at least one mixing element is preferably inside a region of the 3D printer where the filament is present in molten form. Preferably, the at least one mixing element is inside of the nozzle. More preferably, the at least one mixing element is inside of a region of the at least one nozzle where the filament is present in molten form.

The mixing element can be any mixing element known to the person skilled in the art and can be any dynamic or static mixing element. Suitable dynamic or static mixing elements are for example described in WO 2012/152511 A1 or US 2014/0134334 A1.

Preferably, the at least one mixing element is a static mixing element.

For the purposes of the present invention, the term “static mixing element” refers to a device inserted into the 3D printer with the objective of manipulating fluid streams to divide, recombine and swirl the fluid streams as they pass through the static mixing element.

Suitable static mixing elements include, for example, plates, blades, baffle plates, orifice plates, T and Y pieces and mixing elements of more complex geometries, such as alternating right-and left-hand helices, propellers, webs, twisted ribbon or bowtie types with alternating left- and right-hand twists, curve rods forming an X lattice, corrugated panels or crossed elliptical plates with a flat at the centerline, among others. These static mixing elements are usually positioned in specific angles in order to direct flow, increase turbulence and achieve mixing.

Preferably, the at least one mixing element is a static mixing element selected from the group consisting of plates, blades, baffle plates, T and Y pieces, alternating right-and left-hand helices, propellers and curve rods. More preferably, the at least one mixing element is selected from the group consisting of plates and blades, and comprises two or more crossed blades and/or plates. From among these static mixing elements, crossed plates that are vaulted and arranged helically are of particular preference.

The material of the nozzle and/or of the at least one mixing element can usually be any material which remains solid during the operation of the nozzle and includes metals, polymers and/or ceramics. The material of the nozzle and of the at least one mixing element can be identical or different. Preferably, the nozzle and the at least one mixing element are of the same material.

The inside of the nozzle and/or the at least one mixing element can further be coated with a suitable coating material, for example TiN₃, Ni-PTFE (Nickel-polytetrafluoroethylene), Ni-PFA (Nickel-perfluoroalkoxy) or the like.

In a preferred embodiment, the nozzle contains at least one static mixing element inside and the nozzle and the static mixing element are prepared by a selective laser melting (SLM) process.

The selective laser melting (SLM) process is a laser-based process wherein the laser selectively fuses powdered material, for example, a metal powder or a metal powder comprising a binder, by scanning cross-sections generated from a 3D digital description of the part on the surface of a powder bed. After each cross section is scanned, the powder bed is lowered by one layer thickness, a new layer of powder material is supplied on top and the process is completed until the part is complete.

The process for producing the three-dimensional green body preferably comprises the steps a) to e):
a) feeding the filament from a spool into the 3D printer,
b) heating the filament inside the 3D printer,
c) mixing the heated filament by employing the mixing element,
d) extruding the filament obtained in step c) through the nozzle in order to obtain at least one extruded strand,
e) forming the three-dimensional green body layer by layer from at least one extruded strand obtained in step d).

According to step a), the filament is fed from a spool into the 3D printer. If the three-dimensional green body to be prepared comprises a metal alloy, the filament can either comprise a powder of the already prepared metal alloy or a mixture of powders of the individual metal alloy constituents, i. e. the metal and the other element as described above. The metal alloy will then form during the preparation of the three-dimensional green body.

According to step b), the filament is heated inside the 3D printer.

The heating of the filament according to step b) is preferably carried out in the at least one nozzle of the 3D printer.

Preferably, the filament is heated to a temperature above the melting temperature of at least one of the components selected from at least one binder (B) according to component (b), at least one polymer (P) according to component (b1) or at least one thermoplastic polymer (TP) according to component (d).

Methods for the determination of the melting temperatures of the components (b), (b1) and (d) are known to the skilled person. For example, the melting temperature of component (b) can be estimated by differential scanning calorimetry (DSC).

In a preferred embodiment of the present invention, in process step b) the filament is heated to a temperature that is at least 1° C., preferably at least 5° C. and particularly preferably at least 10° C. above the melting point of component (b).

In another preferred embodiment the filament is heated to a temperature in the range of from 140 to 240° C., preferably of from 160 to 220° C.

According to step c), the heated filament is mixed by employing the mixing element.

In step d), the filament heated in step c) is extruded through the at least one nozzle to obtain at least one extruded strand.

The at least one extruded strand generally quickly hardens after the extrusion through the at least one nozzle and is extruded in roughly the same thickness as the nozzle diameter. Preferably, the thickness of the at least one extruded strand is in the range of from 20 μm to 1.5 mm, preferably in the range from 100 μm to 800 μm.

The total surface area of the at least one extruded strand is preferably composed of the at least one inorganic powder (IP), the at least one binder (B), the at least one thermoplastic polymer (TP) and, if present, the at least one additive (A).

The area on the surface of the at least one extruded strand which is covered by the at least one inorganic powder (IP) preferably makes up at least 30%, more preferably at least 35% of the total surface area of the at least one extruded strand.

Moreover, the area on the surface of the at least one extruded strand which is covered by the at least one inorganic powder (IP) preferably makes up not more than 80%, more preferably not more than 70% of the total surface area of the at least one extruded strand.

In a preferred embodiment, the area on the surface of the at least one extruded strand which is covered by the at least one inorganic powder (IP) preferably makes up from 30 to 80%, more preferably from 35 to 70% of the total surface area of the at least one extruded strand.

If the at least one inorganic powder (IP) is selected from the group consisting of a metal or a metal alloy, the surface area of the at least one inorganic powder (IP) relative to the total surface area of the at least one extruded strand can be determined by scanning electron microscopy (SEM).

According to step e), the three-dimensional green body is formed layer by layer from the at least one extruded strand obtained in step d). The formation of the three-dimensional green body is usually carried out using the “layer-based additive technique” by depositing the extruded strands into a building chamber.

The “layer-based additive technique”, for the purposes of the present invention is a technique wherein a first layer of extruded strands is deposited on a base in a build chamber to form a first layer of extruded strands, followed by the deposition of a second layer of extruded strands on the first layer of extruded strands, followed by the deposition of a third layer of extruded strands and so on. The number of layers deposited by the layer-based additive technique depends on the size of the three-dimensional green body. Moreover, the number of layers depends on the thickness of the layers deposited.

The layer thickness is usually in the same range as the thickness of the at least one extruded strand obtained in step d).

The temperature of the building chamber is usually in the range of from 30 to 100° C., preferably of from 40 to 90° C. and particularly preferably of from 50 to 80° C.

In other words, in step a) to e) of the present invention, the filament generally is initially present in a solid state and thereafter melted, then mixed by employing the mixing element, and subsequently printed by extruding strands, which are then applied layer by layer to form the three-dimensional green body.

In one embodiment, the process for producing the three-dimensional green body by a fused filament deposition process comprises the steps i) and ii):
i) depositing a support material into a building chamber using a layer-based additive technique to form a support structure,
ii) depositing a modeling material into the building chamber using the layer-based additive technique to form the three-dimensional green body, wherein the three-dimensional green body comprises at least one region supported by the support structure,
   wherein the support material and the modeling material each comprise extruded strands that are obtained according to steps a) to e) as described above and wherein the support material is obtained from filaments as described above in which the at least one inorganic powder (IP) in the core material (CM) is a ceramic material precursor, and wherein the modeling material is obtained from filaments as described above in which the at least one inorganic powder (IP) in the core material (CM) is selected from the group consisting of a metal and/or metal alloy.

The filaments used for producing extruded strands of the support material are also described in more detail in EP 16203641.2.

It is obvious to the person skilled in the art, that the support material deposited in step i) and the modeling material deposited in step ii) are each extruded via different nozzles.

Steps i) and ii) can be carried out in any order and can be carried out in succession or in alternating order.

Preferably, the production of the three-dimensional green body is followed by a step f) in which at least a part of the binder (B) and/or at least a part of the shell material (SM) are removed from the three-dimensional green body in order to form a three-dimensional brown body.

If the three-dimensional green body comprises a support material and a modeling material and is obtained according to steps i) and ii) as described above, the production of the three-dimensional green body can either be directly followed by a step f) with the support material still attached or the support material can be manually removed from the modeling material prior to step f). Preferably, the production of the three-dimensional green body is directly followed by a step f) with the support material still attached to the modeling material, i.e. step f) is carried out directly after steps i) and ii).

After the at least partial removal of the binder (B) and/or at least a part of the shell material (SM), the resulting three-dimensional object is called a “three-dimensional brown body”. The three-dimensional brown body comprises the inorganic powder (IP), the fraction of the binder (B) and the fraction of the shell material (SM) which were not removed during the step f). The person skilled in the art knows that a three-dimensional brown body comprising a ceramic material precursor as inorganic powder (IP) is also called a three-dimensional white body. However, for the purpose of the present invention, the terms “three-dimensional brown body” and “three-dimensional white body” are used synonymously and are interchangeable.

To remove at least part of the binder (B) in step f) and/or at least a part of the of the shell material (SM), the three-dimensional green body obtained by the fused filament fabrication process is preferably treated with an atmosphere comprising gaseous acid.

Appropriate processes are described, for example, in US 2009/0288739 and U.S. Pat. No. 5,145,900. Step f) is preferably carried out at temperatures below the melting temperature of the binder (B). Step f) is preferably carried out at a temperature at least 1° C. below the melting point of the binder (B), preferably at least 5° C. below the melting point of the binder (B) and particularly preferably at least 10° C. below the melting point of the binder (B).

In general, step f) is carried out at a temperature in the range of from 20 to 180° C. and particularly preferably of from 100 to 150° C. Preferably, step f) is carried out for a period of from 0.1 to 24 h, particularly preferably of from 0.5 to 12 h.

The required treatment time depends on the treatment temperature and the concentration of the acid in the treatment atmosphere and also on the size of the three-dimensional green body.

Suitable acids for step f) of the present invention are, for example, inorganic acids which are either gaseous at room temperature or can be vaporized at the treatment temperature or below. Examples are hydrogen halides and nitric acid. Hydrogen halides are hydrogen fluoride, hydrogen chloride, hydrogen bromide and hydrogen iodide. Suitable organic acids are those, which have a boiling point at atmosphere pressure of less than 130° C., e. g. formic acid, acetic acid or trifluoroacetic acid and mixtures thereof. Acids with boiling points above 130° C., for example methanesulfonic acid, can also be utilized in step f) when dosed as a mixture with a lower boiling acid and/or water. Preferred acids for step f) are nitric acid, a 10% by weight solution of oxalic acid in water or a mixture of 50% by volume of methanesulfonic acid in water.

Furthermore, BF₃ and its adducts with inorganic ethers can be used as acids.

If a carrier gas is used, the carrier gas is generally passed through the acid and loaded with the acid beforehand. The carrier gas, which has been loaded in this way with the acid, is then brought to the temperature at which step f) is carried out. This temperature is advantageously higher than the loading temperature in order to avoid condensation of the acids. Preferably, the temperature at which step f) is carried out is at least 1° C., particularly preferably at least 5° C. and most preferably at least 10° C. higher than the loading temperature.

Preference is given to mixing the acid into the carrier gas by means of a metering device and heating the gas mixture to such a temperature that the acid can no longer condense. Preferably, the temperature is at least 1° C., particularly preferably at least 5° C. and most preferably at least 10° C. higher than the sublimation and/or vaporization temperature of the acid and/or the carrier gas.

The carrier gas in general is any gas that is inert under the reaction conditions of step f). A preferred carrier gas according to the present invention is nitrogen.

It is known to the person skilled in the art that not all components which may be comprised by the binder (B) and/or the shell material (SM) in different embodiments of the invention are removable in step f), due to their chemical and physical properties.

Therefore, the part of binder (B) and/or shell material (SM) which can be removed in step f) in different embodiments of the invention may vary depending on the specific compounds used.

Preferably, step f) is continued until the binder (B) and/or the shell material (SM) have been removed to an extent of at least 40% by weight, more preferably at least 60% by weight, most preferably at least 80% by weight, particularly preferably at least 90% by weight and more particularly preferably at least 95% by weight based on the total weight of the binder (B) and/or the shell material (SM). This can be checked, for example, with the height of the weight decrease.

It is known to the person skilled in the art that at the temperatures of step d), the inorganic powder (IP) comprised in the three-dimensional green body can undergo chemical and/or physical reactions. In particular, the particles of the inorganic powder (IP) can fuse together and the inorganic powder can undergo solid state phase transitions.

The same holds true for the binder (B) and the shell material (SM). During step f), the composition of the binder (B) can change.

Consequently, in one embodiment of the present invention, the inorganic powder (IP), the binder (B) and/or the shell material (SM) comprised in the three-dimensional green body obtained in step e) differs from the inorganic powder (IP) and/or the binder (B) comprised in the three-dimensional brown body obtained in step f).

Step f) can be followed by a step g) in which the three-dimensional brown body is sintered to form a three-dimensional sintered body. Step g) is also called sintering. The terms “step g)” and “sintering” for the purpose of the present invention are synonymous and are used interchangeably throughout the present invention.

In one embodiment, the three-dimensional brown body may comprise parts in which the inorganic powder (IP) is selected from the group consisting a metal and a metal alloy and parts in which the inorganic powder (IP) is a ceramic material precursor. The parts in which the inorganic powder (IP) is a ceramic material precursor may be removed from the three-dimensional brown body prior to or after the sintering. Preferably, the parts in which the inorganic powder (IP) is a ceramic material precursor are removed after the sintering.

After the sintering, the three-dimensional object is a three-dimensional sintered body. The three-dimensional sintered body comprises the inorganic powder (IP) and is essentially free of the binder (B) and the shell material (SM).

“Essentially free of the binder (B) and the shell material (SM)” within the context of to the present invention means that the three-dimensional sintered body comprises less than 5% by volume, preferably less than 2% by volume, particularly preferably less than 0.5% by volume and most preferably less than 0.01% by volume of the binder (B) and the shell material (SM).

It is known to the skilled person that during the sintering process the inorganic powder (IP) is sintered together to give a sintered inorganic powder. Furthermore, during the sintering process the inorganic powder (IP) can undergo chemical and/or physical reactions. Consequently, the inorganic powder (IP) comprised in the three-dimensional brown body usually differs from the sintered inorganic powder comprised in the three-dimensional sintered body.

In one embodiment of the present invention, after step f) and before step g), the three-dimensional brown body obtained in process step f) is heated for preferably 0.1 to 12 h, particularly preferably from 0.3 to 6 h, at a temperature of preferably from 250 to 700° C., particularly preferably from 250 to 600° C. to remove the residual binder (B) and the residual shell material (SM) completely.

The temperature as well as the duration and the atmosphere during step g) depend on the inorganic powder comprised in the at least one filament as component (a). The temperature program of the sintering process, the duration and the atmosphere is in general adapted to the needs of the inorganic powder (IP) comprised in the at least one filament as component (a). Suitable conditions for step g) are known to the skilled person.

In general, step g) is carried out under the atmosphere of a gas that is inert with regard to the inorganic powder (IP) and the binder (B). Typical inert gases are for example nitrogen and/or argon.

Depending on the inorganic powder (IP) comprised in the filament, it is also possible to carry out step g) in air, under vacuum or in hydrogen atmosphere.

The temperature in step g) is in general in the range of from 750 to 1600° C., preferably of from 800 to 1500° C. and particularly preferably of from 850 to 1450° C.

A further subject of the present invention is an extruded strand obtained according to step d) of the process according to the invention.

The extruded strand preferably has a thickness in the range of from 20 μm to 1.5 mm, preferably in the range from 100 μm to 800 μm.

The total surface area of the extruded strand is preferably composed of the at least one inorganic powder (IP), the at least one binder (B), the at least one thermoplastic polymer (TP) and, if present, the at least one additive (A).

The area on the surface of the extruded strand which is covered by the at least one inorganic powder (IP) preferably makes up at least 30%, more preferably at least 35% of the total surface area of the extruded strand.

Moreover, the area on the surface of the extruded strand which is covered by the at least one inorganic powder (IP) preferably makes up not more than 80%, more preferably not more than 70% of the total surface area of the extruded strand.

In a preferred embodiment, the area on the surface of the extruded strand which is covered by the at least one inorganic powder (IP) preferably makes up from 30 to 80%, more preferably from 35 to 70% of the total surface area of the extruded strand.

If the at least one inorganic powder (IP) is selected from the group consisting of a metal or a metal alloy, the surface area of the at least one inorganic powder (IP) relative to the total surface area of the extruded strand can be determined by scanning electron microscopy (SEM).

In a preferred embodiment, the extruded strand has a thickness in the range of from 20 μm to 1.5 mm and the area on the surface of the extruded strand which is covered by the at least one inorganic powder (IP) preferably makes up from 30 to 80%, more preferably from 35 to 70% of the total surface area of the extruded strand.

In an especially preferred embodiment, the extruded strand preferably has a thickness in the range of from 100 μm to 800 μm and the area on the surface of the at least one extruded strand which is covered by the at least one inorganic powder (IP) preferably makes up from 35 to 70% of the total surface area of the at least one extruded strand.

Further subjects of the invention are also the three-dimensional green body, the three-dimensional brown-body and the three-dimensional sintered body prepared by the processes as specified above.

The present invention is further illustrated by the following examples without being restricted thereto.

### A) Filament Preparation

The filament used in the examples is prepared by co-extrusion of the core material and the shell material applying the following materials, equipment and processing parameters.

### Materials:

Core Material:

Core-60: 60 vol % 316L stainless steel powder (D50=8.9 micron, further referred to as inorganic powder (IP)), 4.9 vol % LDPE, 7 vol % poly(1,3-dioxepane) and 28.1 vol % polyacetal (POM)
Shell Material:
POM (Polyacetal; tradename: Ultraform)

### Equipment:

Extrusion equipment: 2 Teach-Line E20T extruders with a Polyolefin Screw 8/6/11 with compression 3.08
Die: modified blow-film die matrix Ø3,6 mm
Additional equipment: Waterbath
Conveyor BAW130T
Zumbach diameter measurement

### Processing Parameters:

All polymers are dried before processing at 80° C. using an air dryer and conveyer speed of 7 m/min.
Core of core material:
Extruder with “Core-60”
Zone 1 190° C., Zone 2 200° C., Skin Adapter 200° C. Die 200° C.
Screw speed 50 RPM
Pressure 14 bar
Outside Layer of shell material:
Co-extrusion with POM Ultraform H2320
Zone 1 175° C., Zone 2 185° C., Skin adapter 190° C.
Screw speed 25 RPM
Pressure 22 bar

### Filament Properties:

Diameter 2.75 mm, Ovality 0.03 mm
Core diameter: 2.45 mm
Outside layer thickness: 0.15 mm

### B) Nozzle Manufacture via SLM

The nozzles used in the following working examples 2 to 4 and 6 to 8 are designed and constructed using Autodesk CAD software and were printed using a SLM (selective laser melting) printer and using tool-grade steel powder. The 3D geometry was exported as a .stl file (standard transformation language) and uploaded to a slicing software, which is then used further by the selective laser melting (SLM) machine software that translates the parameters into physical movement and laser paths for the printing process.

The nozzles were designed to fit a FFF (fused filament fabrication) German RepRap Printer equipped with a DD2 (direct drive version 2) extruder. These nozzles could, for example, also be designed for the thread-based direct drive version 3 (DD3), or a direct drive or Bowden extrusion setup from the company E3D.

### Equipment:

SLM printer: Concept Laser M2 Cusing (from Concept Laser GmbH)
Build Volume: 250×250×280 mm³ (x,y,z)
Laser: Rofins 400 W continuous wave Fiber Laser, wavelength 1070 nm, diameter 50 μm
Heated build plate temperature: 200° C.
Inert Gas Atmosphere: nitrogen (N₂) gas and argon

### Nozzles:

The nozzles prepared in a SLM process comprise static mixing elements and are described as follows:
2 Blade Cross: static mixing element comprising two blades, with the first blade being arranged in the flow direction of the nozzle and the second blade being arranged with 90° rotation in tangential direction relative to the first blade
nozzle feed diameter: 3.0 mm
nozzle extrusion diameter: 0.4 mm
nozzle length: 3 cm
2 Plate Cross: static mixing element comprising two vaulted plates arranged helically
nozzle feed diameter: 3.0 mm
nozzle extrusion diameter: 0.4 mm
nozzle length: 3 cm
3 Blade Cross: static mixing element comprising three blades, with the first and the third blade arranged in the flow direction of the nozzle and the second blade being arranged with 90° rotation in tangential direction relative to the first and third blade
nozzle feed diameter: 3.0 mm
nozzle extrusion diameter: 0.4 mm
nozzle length: 3 cm

These nozzles are suitable for use with 2.75 mm filaments in fused filament fabrication (FFF) processes.

The nozzle used in the comparative examples CE1 and CE5 is a purchased standard bronze nozzle without static mixing elements.

### C) Fused Filament Fabrication

### Example 1

Printer: German Reprap X400 Dual Extrusion (FFF Desktop Standard, open source software compatible)
Software: open source software (i.e. Cura, Simplify3d, Slic3r)
Hardware: direct drive dual extruder print heads with modular hotend (temperature limit 270° C.), heated bed

A CAD file is loaded into the slicing software and the printing configuration is set according to desired speed and quality requirements.

The printhead of the 3D printer is loaded with the filament. The printhead is fitted with the appropriate extrusion nozzle (either a purchased standard bronze nozzle without static mixing elements or a nozzle with static mixing elements prepared by selective laser melting (SLM) as described above) and jacketed with a 3D printing standard hotend with heating element and thermal measurement transistor (thermistor). For the metal composite filament systems bound with POM, the typical hotend temperature is 210° C. to 220° C. The temperature is not to exceed 230° C. to prevent degradation of the binding material.

The extruded strands are then collected and their surface is analyzed via scanning electron microscopy (SEM). According to SEM, an electron beam is irradiated onto the at least one strand, which generates secondary electrons from the metal particles of the inorganic powder (IP) in the at least one extruded strand as ionization products. Based on the generated secondary electrons, SEM images are created which are typically gray-scale raster images, where each pixel position includes an integer value between 0 (black, only thermoplastic polymer) and 255 (white, only metal particles) representing brightness or intensity. The analysis of the scans provided by SEM is carried out using the software ImageJ.

A total grayscale level is calculated from a gray value of an area of interest within an image. The gray value is thus determined from the average of all pixels in a given area and the higher the gray values are, the more inorganic powder (IP) is present on the surface in the given area. The relative gray value is then determined as an average of all gray-scale values provided in the SEM measurements and is used to calculate the area of the inorganic powder (IP) relative to the total surface area of the at least one strand. The determination of the relative gray value is carried out using Microsoft Excel.

Table 1 shows the total surface area, the area on the surface of the extruded strand which is covered by inorganic powder and the area of the inorganic powder relative to the total surface area for strands extruded from different extrusion nozzles. The nozzle of Comparative Example 1 (CE1) does not comprise any mixing elements, whereas the nozzles used to extrude the strands in inventive Examples E2 (2 Blade Cross), E3 (2 Plate Cross) and E4 (3 Blade Cross) comprise static mixing elements. Each nozzle used has a feed opening diameter of 3.0 mm, an extrusion diameter of 0.4 mm and a length of 3 cm.

TABLE 1

| | | | Area of Inorganic |
|---|---|---|---|
| | Total Surface Area | Area of Inorganic | Powder relative to |
| Example | [μm²] | Powder [μm²] | total Surface Area |
| CE1 | 563 844.2 | 111 682.9 | 20% |
| E2 | 480 282.7 | 203 065.8 | 42% |
| E3 | 521 851.6 | 301 977.5 | 58% |
| E4 | 514 860.9 | 196 528.8 | 38% |

The Examples in Table 1 clearly show that the use of a nozzle having static mixing elements greatly improves the distribution of inorganic powder (IP) on the total surface area of the extruded strands.

### Example 2

To test the stability of the green parts printed and of the resulting brown parts using nozzles with and without mixing elements, test parts are printed and the resulting green bodies are debound according to the procedure described above to give the respective brown bodies. Each green body is printed in the shape of a ring having a radius of 30 mm and a height of 12 mm. The edge of the ring is designed in the pattern of a weaving. For each run, 2 copies were printed.

The printing parameters for all samples are:
Nozzle Extrusion Diameter: 0.4 mm
Filament Feed Diameter: 2.75 mm
Nozzle Temperature: 215° C.
Heated Bed Temperature: 80° C.
Printing Speed: 30 mm/s
Layer Thickness: 0.2 mm

Debinding experiments using a standard laboratory oven (50 L) are then performed on each green body, using 40 g/h of nitric acid and 500 L/h of N₂. The oven is first purged for 1 hour with N₂, at the same time the oven is heated gradually to 110° C. The debinding is allowed to complete for 3 hours after which the flow of nitric acid is stopped and the parts are allowed to cool down to room temperature under N₂ purge.

After successful debinding, the delicate parts can be moved into the sintering oven. For the experiments, the sintering oven is programmed for the following ramping and heating cycle. The sintering oven is first flushed with H₂ gas. The temperature is then ramped by 5° C./min until a temperature of 600° C. is reached. The oven is held at 600° C. for the period of 1 hour, after which the temperature is ramped by 5° C./min to 1300° C. This temperature is held for a period of 2 h, after which the oven is cooled at a rate of 5 to 10° C./min.

In order to evaluate the stability, the permanent deformation of the produced brown bodys and sintered bodies is assessed. A summary of these results is given in Table 2.

TABLE 2

| Example | Mixing Element | Debinding Result | Sintering Result |
|---|---|---|---|
| CE5 | None | both samples broke | not applicable |
| E6 | 2 Blade Cross | both samples intact | metal part successful |
| E7 | 2 Plate Cross | both samples intact | metal part successful |
| E8 | 3 Blade Cross | both samples intact | metal part successful |

No measureable permanent deformation is observed on the samples of Examples 6 to 8 (E6 to E8), which are produced by using a nozzle containing static mixing elements. In contrast, the samples of Comparative Example 5 (CE5), which are produced using a nozzle without any mixing elements, have broken under their own weight after the debinding step and sintering is not applicable.

1.-18. (canceled)

19. A process for producing a three-dimensional green body by a fused filament fabrication process employing at least one filament and a three-dimensional extrusion printer (3D printer), wherein
at least one filament comprises a core material (CM) coated with a layer of shell material (SM), wherein
the core material (CM) comprises the components (a) to (c)
(a) 30 to 80% by volume, based on the total volume of the core material (CM) of at least one inorganic powder (IP), wherein the inorganic powder (IP) is a powder of at least one inorganic material selected from the group consisting of a metal, a metal alloy and a ceramic material precursor
(b) 20 to 70% by volume, based on the total volume of the core material (CM) of at least one binder (B) comprising component (b1)
(b1) at least one polymer (P)
(c) 0 to 20% by volume, based on the total volume of the core material(CM) of at least one additive (A),
and the shell material (SM) comprises the components (d) to (f)
(d) 75 to 100% by volume, based on the total volume of the shell material (SM) of at least one thermoplastic polymer (TP)
(e) 0 to 20% by volume, based on the total volume of the shell material (SM) of the at least one inorganic powder (IP),
(f) 0 to 25% by volume, based on the total weight of the shell material (SM) of the at least one additive (A),
and the 3D printer contains at least one nozzle and at least one mixing element, wherein the at least one mixing element is a static mixing element.

20. The process according to claim 19 comprising the steps a) to e)
a) feeding the filament from a spool into the 3D printer,
b) heating the filament inside the 3D printer,
c) mixing the heated filament by employing the mixing element,
d) extruding the filament obtained in step c) through the nozzle in order to obtain at least one extruded strand,
e) forming the three-dimensional green body layer by layer from at least one extruded strand obtained in step d).

21. The process according to claim 19, wherein
i) the 3D printer contains at least one printhead containing at least one nozzle and at least one mixing element, and/or
ii) the mixing element is a static mixing element, and/or
iii) the mixing element is inside of the nozzle, and/or
iv) the nozzle has an extrusion diameter of <1.5 mm,

22. The process according to claim 19, wherein
i) in step b), the filament is heated to a temperature above the melting temperature of at least one of the components selected from at least one binder (B) according to component (b), at least one polymer (P) according to component (b1) or at least one thermoplastic polymer (TP) according to component (d), and/or
ii) the heating of the filament according to step b) is carried out inside of the nozzle.

23. The process according to claim 19, wherein the nozzle contains at least one static mixing element inside and the nozzle and the static mixing element are prepared by a selective laser melting (SLM) process.

24. The process according to claim 19, wherein in the filament the binder (B)
i) comprises from 50 to 96% by weight or the at least one polymer (P), based on the total weight of the binder,
ii) the at least one polymer (P) is a polyoxymethylene (POM).

25. The process according to claim 19, wherein in the filament the binder (B) in the core material (CM) comprises components (b2) and/or (b3)
(b2) at least one polyolefin (PO),
(b3) at least one further polymer (FP), in case component (b1) is a polyoxymethylene (POM),

26. The process according to claim 25, wherein in the filament the binder (B) comprises 2 to 35% by weight of component (b2), based on the total weight of the binder (B), and/or from 2 to 40% by weight of component (b3), based on the total weight of the binder (B).

27. The process according to claim 19, wherein
i) the diameter of the filament is 1.5 to 3.5 mm, and/or
ii) the diameter of the core material is 1.3 to 3.0 mm, and/or
iii) the thickness of the layer of shell material (SM) is 0.05 to 0.5 mm, and/or
iv) the particle size of the inorganic powder (IP) is from 0.1 to 80 μm, and/or
v) the at least one thermoplastic polymer (TP) of the shell material (SM) is selected from the group consisting of polyoxymethylene (POM), polyolefins (PE), polyurethanes (PU), polyamides (PA), polyethers (PETH), polycarbonates (PC), polyesters (PES) and blends thereof.

28. The process according to claim 19, wherein in the filament the polymer (P) in component (b1) is a polyoxymethylene (POM) copolymer which is prepared by polymerization of
from at least 50 mol-% of a formaldehyde source (b1a),
from 0.01 to 20 mol-% of at least one first comonomer (b1b) of the general formula (II) 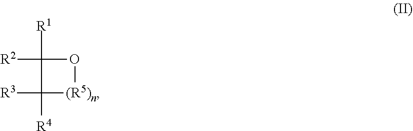
wherein
R¹ to R⁴ are each independently of one another selected from the group consisting of C₁-C₄-alkyl and halogen-substituted C₁-C₄-alkyl;
R⁵ is selected from the group consisting of a chemical bond, a (—CR^{5a}R^{5b}—) group and a (—CR^{5a}R^{5b}O—) group,
wherein
R^{5a} and R^{5b} are each independently of one another selected from the group consisting of H and unsubstituted or at least monosubstituted C₁-C₄-alkyl,
wherein the substituents are selected from the group consisting of F, Cl, Br, OH and C₁-C₄-alkyl;
n is 0, 1, 2 or 3;
and
from 0 to 20 mol-% of at least one second comonomer (b1c) selected from the group consisting of a compound of formula (III) and a compound of formula (IV) 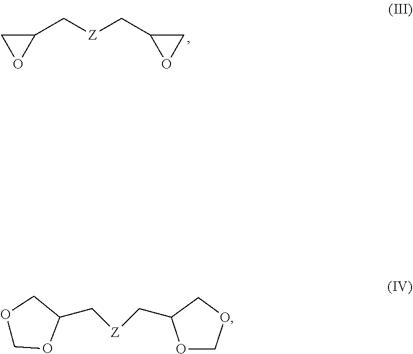
wherein
Z is selected from the group consisting of a chemical bond, an (—O—) group and an (—O—R⁶—O—) group,
wherein
R⁶ is selected from the group consisting of substituted C₁-C₈-alkylene and C₃-C₈-cycloalkylene.

29. The process according to claim 25, wherein in the filament the further polymer (FP) is at least one further polymer (FP) selected from the group consisting of a polyether, a polyurethane, a polyepoxide, a polyamide, a vinyl aromatic polymer, a poly(vinyl ester), a poly(vinyl ether), a poly(alkyl (meth)acrylate) and copolymers thereof.

30. The process according to claim 19, wherein the production of the three-dimensional green body is followed by a step f) in which at least a part of the binder (B) and/or at least a part of the shell material (SM) is removed from the three-dimensional green body in order to form a three-dimensional brown body.

31. The process according to claim 30, wherein step f) is followed by a step g), in which the three-dimensional brown body is sintered to form a three-dimensional sintered body.

32. A three-dimensional green body, prepared by the process according to claim 19.

33. A three-dimensional brown body, prepared by the process according to claim 30.

34. A three-dimensional sintered body, prepared by the process according to claim 31.

35. An extruded strand obtained according to step d) of claim 20.

36. The extruded strand according to claim 35, wherein
i) the thickness of the extruded strand is in the range of from 20 μm to 1.5 mm, and/or
ii) the area on the surface of the extruded strand which is covered by the at least one inorganic powder (IP) makes up at least 30% of the total surface area of the extruded strand, and/or
iii) the area on the surface of the extruded strand which is covered by the at least one inorganic powder (IP) makes up not more than 80% of the total surface area of the extruded strand.
